(19) United States
(12) Patent Application Publication
(10) Pub. No.: US 2011/0264335 A1
(43) Pub. Date: Oct. 27, 2011

(54) ROBUST CONTROL FOR ENGINE ANTI-STALL

(75) Inventors: Side Zhao, Fairview, OR (US); Ronald G. Warnecke, Fairview, OR (US)

(73) Assignee: NMHG OREGON, LLC, Fairview, OR (US)

(21) Appl. No.: 13/082,290

(22) Filed: Apr. 7, 2011

Related U.S. Application Data
(60) Provisional application No. 61/326,976, filed on Apr. 22, 2010.

(51) Int. Cl. F02D 45/00

(52) U.S. Cl. 701/50

(57) ABSTRACT

A processing device is configured to identify an initial engine speed of an industrial vehicle and monitor a rate of change in engine speed. A variable hydraulic flow device is configured to vary a hydraulic flow associated with a hydraulic system based, in part, on the rate of change in the engine speed. The engine speed may be maintained at or below the initial engine speed while the hydraulic flow is varied.

### CROSS REFERENCE TO RELATED APPLICATIONS

This application is a non-provisional of U.S. Provisional Application Ser. No. 61/326,976 filed Apr. 22, 2010, the disclosure of which is herein incorporated by reference in its entirety.

### BACKGROUND

An industrial vehicle, such as a forklift truck, operating in a warehouse, lumber yard, dock, plant, or other facility may transport and/or lift loads. The industrial vehicle may comprise a hydraulic system configured to perform a hoist function or provide a lifting force that lifts the load. Typically, the hydraulic system includes a hydraulic pump that is powered by a motor or engine, such as a diesel engine or a spark ignited internal combustion engine.

A fixed displacement hydraulic pump may output hydraulic flow in proportion to an engine speed or number of revolutions per minute (RPM) of the engine. If a high work pressure is suddenly demanded at a low engine RPM, then engine stall may occur unless some mechanical prevention is implemented.

The hydraulic system may comprise an unloader configured to sense the pump pressure and the load pressure. In a closed center hydraulic system, a fixed displacement pump may output the hydraulic flow at the margin pressure of the unloader unless work is being done. Mechanical anti-stall valves may cause a certain amount of hydraulic oil to be bypassed in parallel. A solenoid valve may be used to bleed off hydraulic flow to control the pressure rise rate of the system when a load is imposed. A portion of the hydraulic flow may be dumped to the hydraulic tank to mitigate the rate of pressure increase. In some systems, the engine speed may be increased to respond to the increased torque demands of the hydraulic load. The engine speed may be increased responsive to a change in hydraulic pressure or measured load.

When the industrial vehicle is performing the hoist function, the industrial vehicle may otherwise be stationary or be associated with a zero travel speed. Bleeding off hydraulic fluid or increasing engine speed may reduce fuel economy, increase noise pollution, and/or affect control response of the hydraulic system.

### SUMMARY

A method is disclosed herein as comprising identifying an initial engine speed of an industrial vehicle and monitoring a rate of change in engine speed. The method may further comprise controlling a hydraulic pump to vary a hydraulic flow associated with a hydraulic system based, in part, on the rate of change in the engine speed. The engine speed may be maintained at or below the initial engine speed while the hydraulic flow is being varied.

A system is disclosed as comprising a processing device and a variable displacement pump. The processing device may be configured to identify an initial engine speed of an industrial vehicle and monitor a rate of change in engine speed. The variable displacement pump may be configured to vary a hydraulic flow associated with a hydraulic system based, in part, on the rate of change in the engine speed. The engine speed may be maintained at or below the initial engine speed while the hydraulic flow is varied.

An apparatus is disclosed as comprising means for identifying an initial engine speed of an industrial vehicle and means for monitoring a rate of change in engine speed. The apparatus may further comprise means for varying a hydraulic flow associated with a hydraulic system based, in part, on the rate of change in the engine speed, and means for maintaining the engine speed at or below the initial engine speed while the hydraulic flow is being varied.

### BRIEF DESCRIPTION OF THE DRAWINGS

FIG. 1 is a logic diagram illustrating an example fueling system associated with an engine.

FIG. 2 is a logic diagram illustrating a manifold air dynamics associated with an engine.

FIG. 3 illustrates an example hydraulic schematic of a hydraulic system comprising a variable displacement pump.

FIG. 4 is a block diagram illustrating a control system for an industrial vehicle's hydraulic system.

FIGS. 5A and 5B illustrate a logic diagram for an engine anti-stall control system.

FIGS. 6A and 6B are simplified diagrams illustrating the engine anti-stall control system as depicted in FIGS. 5A and 5B.

FIG. 7 is an architectural diagram illustrating the engine anti-stall control system as depicted in FIGS. 5A and 5B.

FIG. 8 is an example look-up table illustrating a hydraulic load factor.

FIG. 9 is a logic diagram illustrating a system configured to accumulate an engine speed offset.

FIG. 10 is a simplified diagram illustrating the accumulator system depicted in FIG. 9.

FIG. 11 illustrates an example process for varying hydraulic flow to prevent engine stall.

### DETAILED DESCRIPTION

When an engine is operating near idle speeds, the amount of torque that is applied may be a fraction of the total available torque of the engine. The ability of a hydraulic system to provide sufficient hoist function while an engine is at idle speed may determine how responsive the vehicle is to receiving the associated operator command.

The engine speed may be increased to provide additional torque capacity. The increased engine speed may result in a louder noise of the industrial vehicle, reduced fuel economy, and increased pollution. Systems which bleed, vent, or dump hydraulic fluid, such as with the use of a solenoid valve, may also provide additional torque capacity.

Systems configured to avoid stalling the vehicle engine during a low engine speed and/or part throttle operation may include limiting the maximum pump flow rate according to the engine revolution speed, limiting the pump flow rate command ramp rate according to the engine revolution speed, and/or adjusting hydraulic torque load to the engine according to engine revolution speed and/or engine revolution acceleration. These types of systems may be defined according to the maximum work load, which may produce slow control response in a number of truck working conditions.

The torque applied to the engine may be a product of the pressure in the hydraulic system and the amount of displacement of hydraulic flow. Unlike the fixed displacement pump, a variable displacement pump (VDP) or a piston type pump may vary its pump flow independent of the engine revolution speed. The VDP may operate in an internal combustion engine (ICE) trucks such as a spark ignited or diesel powered vehicle. The engine revolution speed may limit the maximum pump flow capability of the VDP. When the VDP utilizes a load-sensing control, the pump may automatically adjust itself to any load demand within the flow and pressure boundaries of the pump control. By controlling the flow command to the control valve, e.g., the hydraulic valve opening, the load sensing control may automatically control the pump displacement of the piston pump and control the hydraulic torque load to the engine. The load sensing control can be either hydro-mechanical or electro-proportional. By controlling the hydraulic torque applied to the engine, engine stall may be avoided.

When a manual control valve is utilized, the valve opening may be controlled by the operator. Therefore, the VDP utilizing an electro-proportional control may be controlled directly. In some embodiments, the valve opening on the manual control valve may not be over-ridden. The anti-stall control may directly control an electronically controlled pump by over-riding or altering the load sense signal.

A variable displacement pump may prevent engine stall and provide satisfactory control response and fuel economy without a mechanical intervention, e.g., without an anti-stall solenoid valve, that may be found with a fixed displacement gear pump in a closed or open center hydraulic system. Based on the engine dynamics and management, the control performance index of the engine anti-stall control may be determined.

Engine Dynamics

A Spark Ignition (SI) Mean Value Engine Model (MVEM) may be used to analyze the engine dynamics characteristics, as described by Elbert Hendricks, “Engine Modeling for Control Applications: A Critical Survey,” Meccanica 32: 387-396, 1997. This model has three main subsystems comprising fuelling dynamics, crankshaft dynamics, and manifold air dynamics. The model may also apply to SI engine systems as well as diesel engine systems.

Fuelling Dynamics

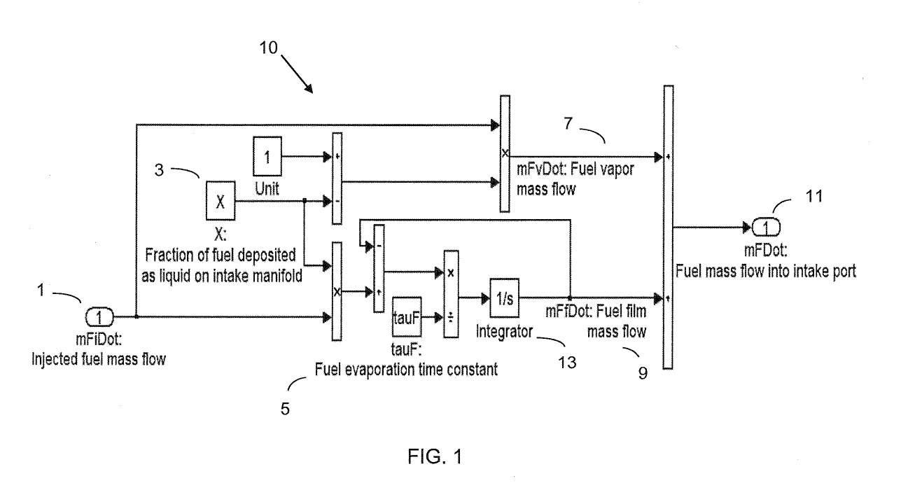

The fuelling dynamics may be graphically expressed using a simulated block diagram. FIG. 1 is a logic diagram illustrating an example fueling system 10 associated with an engine. In this example, an SI engine with a fuel supply and delivery system with intake manifold injection is considered. The fuelling dynamics of MVEM may be written as:

$$\begin{matrix}{\ddot{m}}_{ff} = \frac{1}{{τ}_{f}} ( - {\dot{m}}_{ff} + X {\dot{m}}_{fi} ) & ( 1 ) \\ {\dot{m}}_{fv} = ( 1 - X ) {\dot{m}}_{fi} & ( 2 ) \\ {\dot{m}}_{f} = {\dot{m}}_{fv} + {\dot{m}}_{ff} & ( 3 )\end{matrix}$$

Where

\dot{m}_{f}—fuel mass flow into intake port 11, expressed in [kg/s]

\dot{m}_{ff}—fuel film mass flow 9, expressed in [kg/s]

\ddot{m}_{ff}—fuel film mass flow change rate [kg/s2]

\dot{m}_{fi}—injected fuel mass flow 1, expressed in [kg/s]

\dot{m}_{fv}—fuel vapor mass flow 7, expressed in [kg/s]

τ_{f}—fuel evaporation time constant 5, expressed in [s]

X—fraction of the fuel deposited as liquid on intake manifold 3, expressed in [%]

From the equations (1), (2), and (3) and the example fueling system 10 depicted in FIG. 1, the relationship between the fuel mass flow \dot{m}_{f} to the combustion chamber 11 and the injected fuel mass flow \dot{m}_{fi} from the fuel injectors 1 may be understood to comprise a first order system. In one embodiment, there may be a phase delay due to an integrator 13.

Crankshaft Dynamics

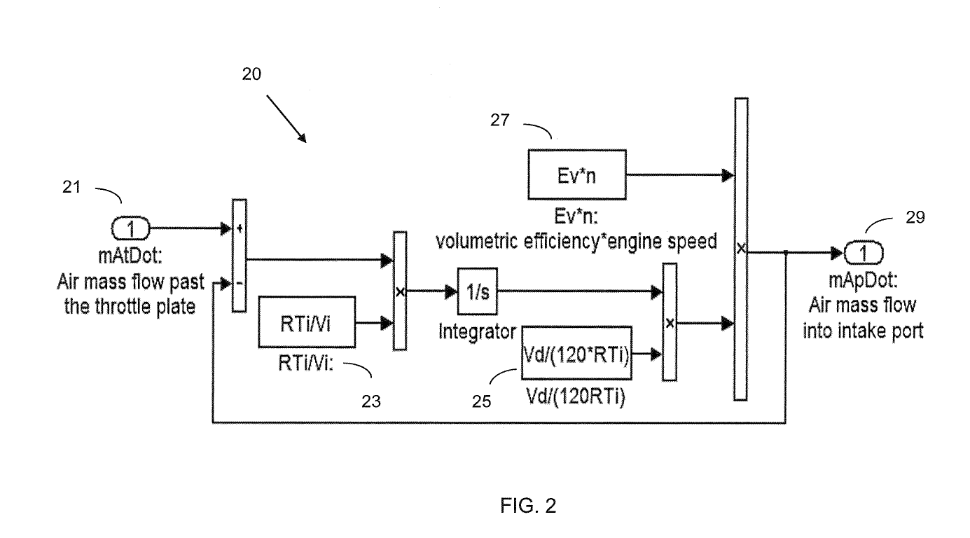

FIG. 2 is a logic diagram illustrating manifold air dynamics 20 associated with an engine. The crankshaft speed state equation may be written as:

$$\begin{matrix}\dot{n} = \frac{1}{In} ( - ( {P}_{l} + {P}_{b} ) + {H}_{u} {η}_{i} {\dot{m}}_{f} ( t - {τ}_{d} ) ) & ( 4 ) \\ {τ}_{d} = \frac{60}{n} [ 1 + \frac{1}{{n}_{cyl}} ] + \frac{{ρ}_{i} {l}_{e} {A}_{i}}{{\dot{m}}_{at}} & ( 5 )\end{matrix}$$

Where

n—engine speed [rpm]

\dot{n}—engine revolution acceleration [rpm2]

I—engine inertia [kg·m2]

Pₗ—engine loss power [kW]

P_{b}—engine load power [kW]

Hᵤ—fuel lower heating value [kJ/kg]

η—thermal efficiency[%]

τ_{d}—time delay from the fuel injection to the torque [s]

n_{cyl}—number of cylinders

ρᵢ—density of the air in the intake manifold

lₑ—effective distance between the fuel injector and the intake valve

Aᵢ—effective cross sectional area of the intake manifold

\dot{m}ₐₜ—air mass flow past the throttle plate 21

The equation (4) represents an example application of Newton's second law as applied to the engine. The engine revolution acceleration may be proportional to the residual torque, comprising the subtraction of the torque generated by the fuel and the torque used to drive the work load and the parasitic load. In one embodiment, there may be a pure time delay due to the time spans among the four strokes and the air flow travel time. Therefore, this subsystem, with the input as the fuel mass flow to the combustion chamber \dot{m}_{f} and the output as the engine speed n, may be described as a first order system with a pure time delay.

Manifold Air Dynamics

The manifold pressure state equation may be derived using the conservation of air mass in the intake manifold and the ideal gas law.

$$\begin{matrix}{\dot{p}}_{i} = \frac{{RT}_{i}}{{V}_{i}} ( - {\dot{m}}_{ap} + {\dot{m}}_{at} ) + {p}_{i} \frac{{\dot{T}}_{i}}{{T}_{i}} & ( 6 ) \\ {\dot{m}}_{ap} = \frac{{V}_{d}}{120 {RT}_{i}} ( {e}_{v} \cdot {p}_{i} ) n & ( 7 )\end{matrix}$$

Where

pᵢ—absolute manifold pressure [bar]

R—gas constant [kJ/kgK]

Tᵢ—intake manifold temperature [K]

Vᵢ—manifold and port passage volume [m3]

\dot{m}ₐₚ—the air mass flow into intake port 29, expressed in [kg/s]

V_{d}—engine displacement

e_{V}—volumetric efficiency based on manifold conditions 27, expressed in [%]

Neglecting the term on the far right of equation (6), the manifold air dynamics may be graphically expressed with a simulated block diagram such as the logic diagram 20 depicted in FIG. 2. From the equations (6) and (7) and the logic diagram depicted in FIG. 2, the manifold air dynamics, with the input as the air mass flow pass the throttle plate \dot{m}ₐₜ 21 taken together with the output as the air mass flow into intake port \dot{m}ₐₚ 29, may be simplified as a nonlinear low-pass filter.

The gas constant, intake manifold temperature, and manifold and port passage volume are introduced in the logic diagram 20 at entry point 23. The intake manifold temperature, and manifold and port passage volume are also introduced in the logic diagram 20 at entry point 25 together with the engine displacement. The open-loop engine dynamics may be considered roughly as a 2nd order multi-input-multi-output (MIMO) system with a certain pure time delay.

Engine Management

There are many engine management strategies that may be employed for an industrial vehicle. An incomplete list of strategies includes: engine start strategy, engine post-start strategy, engine warm-up phase strategy, lambda closed-loop control strategy, exhaust-gas recirculation control strategy, and camshaft timing control strategy. Strategies that are mainly concerned in developing the engine anti-stall control system may comprise one or more of the following strategies: transition compensation strategy, closed-loop idle-speed control strategy, normal engine speed control strategy, and normal engine torque control strategy.

Different engines may adopt different strategies and control methods. An engine may be used with a Proportional-Integral-Derivative (PID) type controller to control the throttle and fuel injection to achieve the engine speed/torque output requirements. With the engine dynamics modeled as a second order Multi-Input, Multi-Output (MIMO) system, PID controls may be configured to achieve full state-feedback control, and may remove steady-state errors.

The steady-state and transient control performances of a PID type controller may be tuned through modifying the P-gain, D-gain and I-gain. However, once the gains are defined, its performances may also be determined. If the performance requirements of some application scenarios, especially those with high transient performance requirements, exceed the capabilities of the controller, the engine may become stalled.

In a VDP hydraulic system with load sensing control, the hydraulic flow rate command may change the load applied to the engine. The load to the engine may be controlled to be within the engine capabilities. The engine anti-stall control system may adjust the hydraulic torque load to the engine so that the engine controller can meet the transient performance requirement as well as the steady-state performance requirement of the application, and keep the engine from stalling.

Hydraulic Circuit Analysis

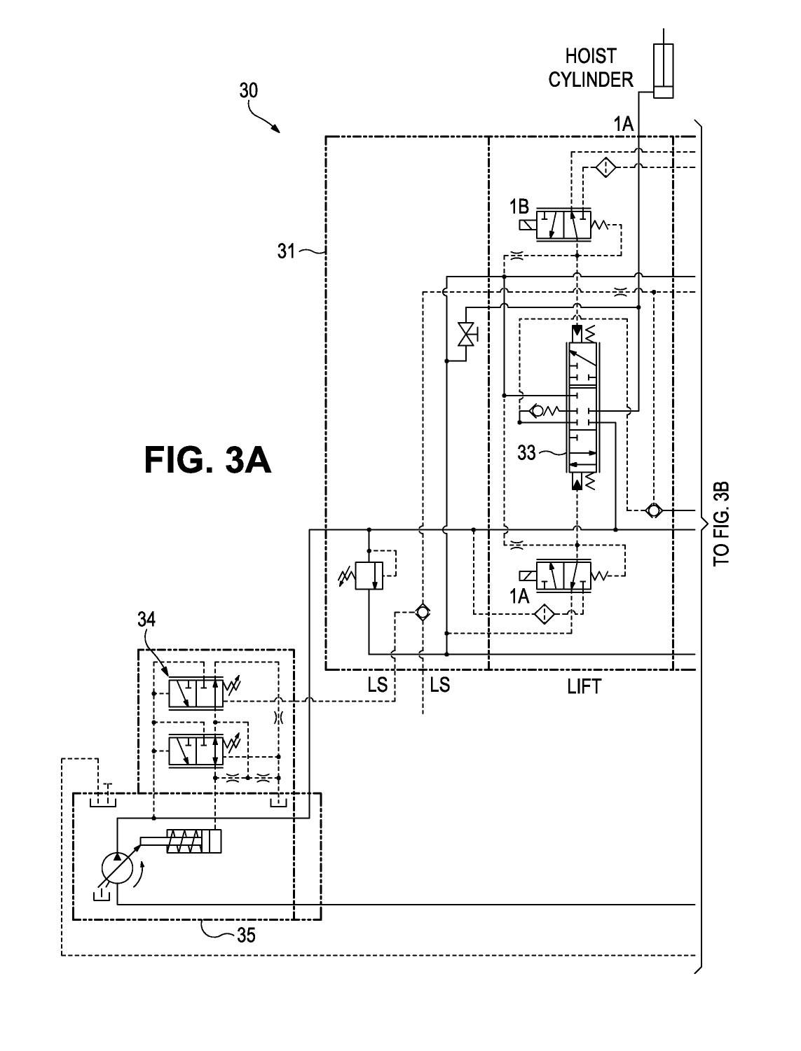

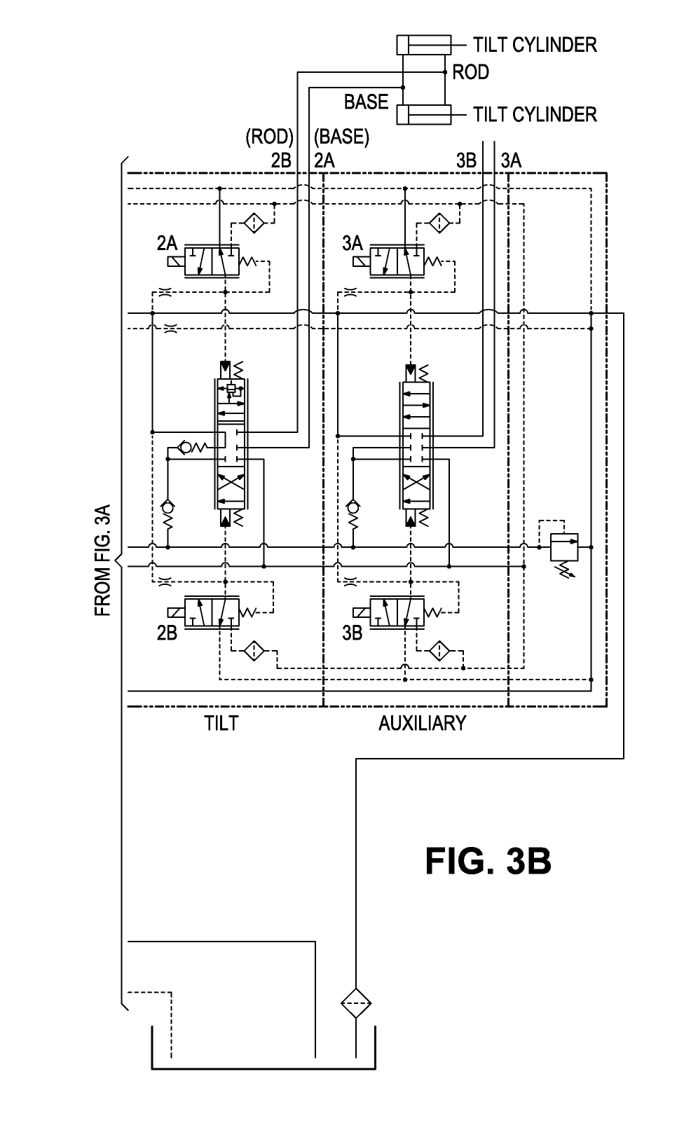

FIG. 3 illustrates an example hydraulic schematic of a hydraulic system 30 comprising a variable displacement pump 35, a load sensing flow control 34, a load sensing control valve 31, and a hydraulic function valve 33. From the pump configuration it can be seen that the pump flow in the hydraulic system 30 may not be proportional to the engine RPM. Instead, the pump flow may be substantially proportional to the multiplication of the engine RPM and the pump displacement. The power balance can be expressed as:

$$p \cdot q = \frac{1}{44.15} {T}_{l} \cdot n \qquad ( 8 )$$

Where

p—pump pressure [psi]

q—pump flow rate [gpm] which is proportional to the product of engine speed and pump displacement

n—engine speed [rpm]

Tₗ—hydraulic torque load onto the engine [lb-in]

$$\frac{1}{44.15} - the conversion factor between the imperial units and the SI units .$$

Through changing the displacement of the pump, e.g., by changing the angle of the swash plate, the hydraulic torque load to the engine may be changed. By adding and/or reducing the hydraulic torque load to the engine properly, the engine anti-stall may be realized.

FIG. 3 also shows that the displacement of the pump (pump flow rate) may be controlled indirectly. The pump flow rate may be controlled, such as by varying the swash plate angle, to maintain the load sense pressure-to-pump pressure ΔP at around the specified pump control margin. In response to changing the hydraulic valve opening, the pump flow rate may be controlled.

In one embodiment, the flow rate command may be calculated according to the operator control input command and the available pump flow model, definition, and/or setting. By utilizing the engine anti-stall control system in the subsystem to calculate the available pump flow, the flow rate commands to the hydraulic operations may be controlled.

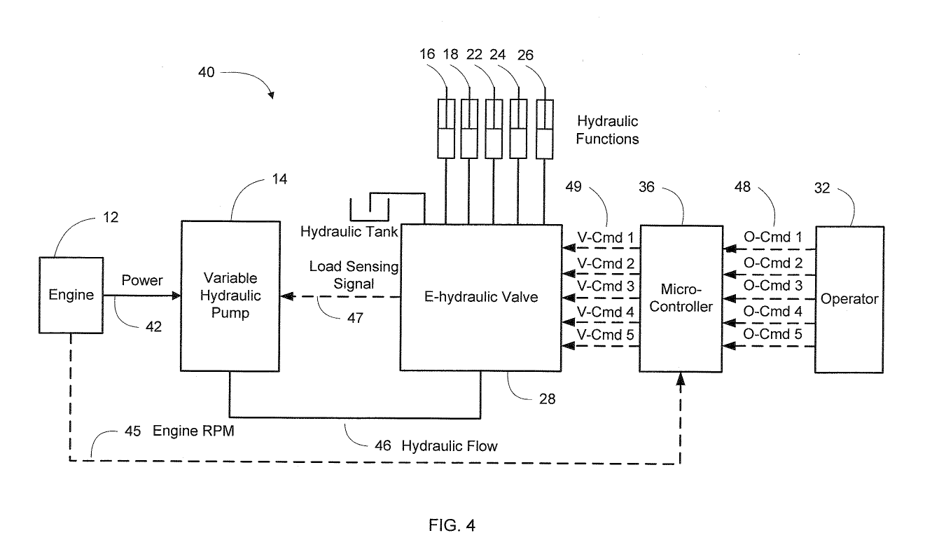

FIG. 4 is a block diagram illustrating a control system 40 for an industrial vehicle's hydraulic system. A microcontroller 36 controls the activation of the E-hydraulic valve 28 according to the engine speed 45 and the command inputs 48 of the operator 32.

The microcontroller may receive the hydraulic commands 48 from the operator 32 through a device that can be a joystick or an individual lever module. It may also receive the engine speed signal 45, which can be in the form of Revolution Per Minute (RPM), and can be derived from the Engine Control Unit (ECU) through Control Area Network (CAN) or from the measurement of a speed sensor that is directly connected to the microcontroller. Based on these commands and measurements, and the logics programmed in the processing unit, the microcontroller may calculate the flow rate commands, the spool displacements of the E-hydraulic valve 28, and generate the valve commands 49, which can be driving currents.

The E-hydraulic valve 28 may open according to the driving currents from the microcontroller 36. As a result of the valve opening, the load sense signal 47 may be fed to the variable hydraulic pump 14, which may be driven to have nonzero displacement. With nonzero displacement, the variable hydraulic pump 14 may draw power 42 from the engine 12, and supply hydraulic flow 46 to the E-hydraulic valve 28. Based on the openings of different spools, the hydraulic valve may distribute the hydraulic flow 46 to different hydraulic functions 16, 18, 22, 24 and 26. The engine 12 may supply torque and maintain its target speed, which is set by the ECU and the operator command.

Engine Anti-Stall Control for Hydraulic Operations

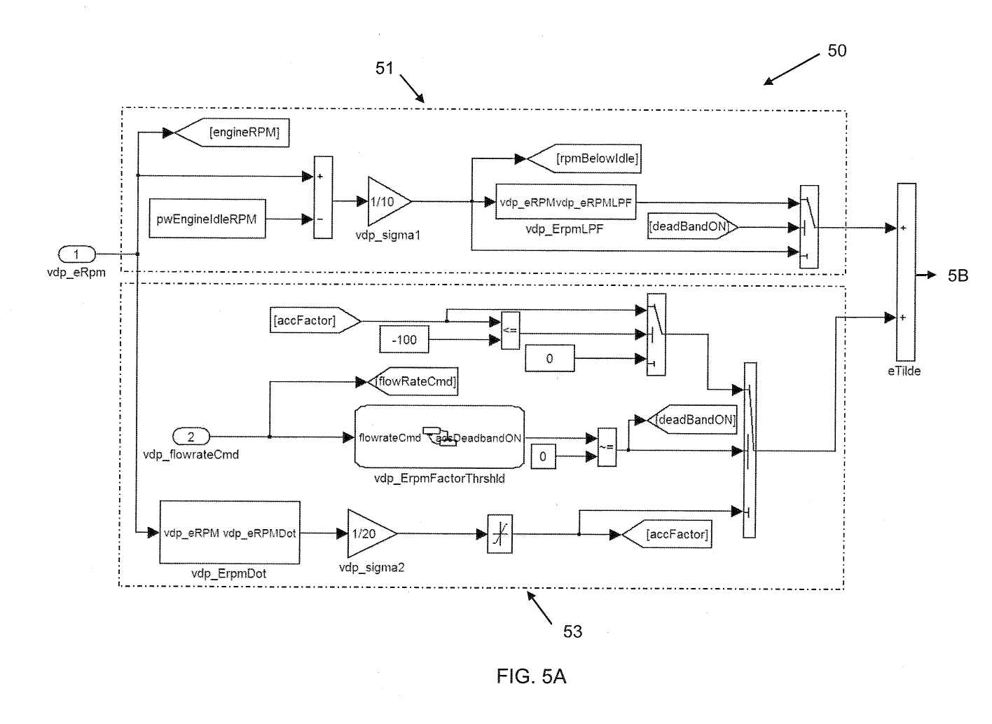

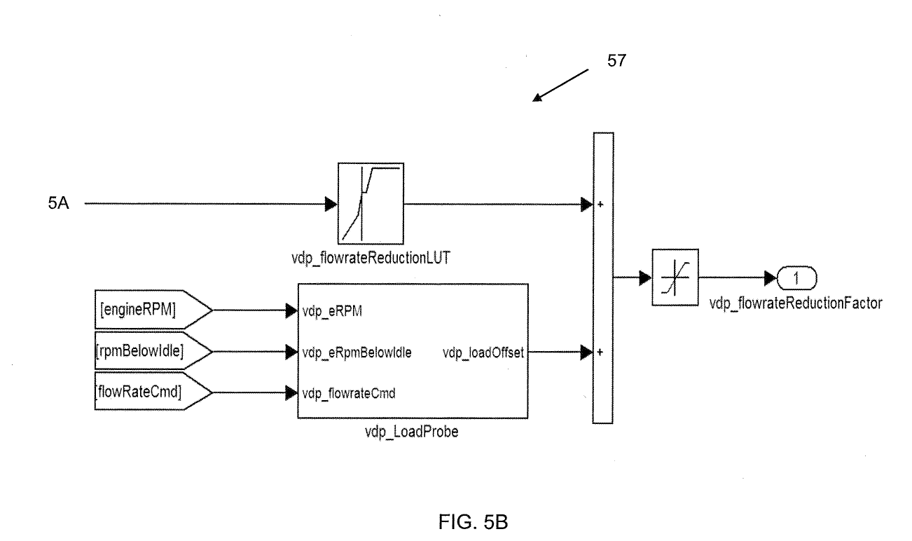

FIGS. 5A and 5B illustrate a logic diagram for an engine anti-stall control system 50. The system 50 may be configured to measure the engine's response to the load, adjust the variable displacement pump's flow rate through controlling the hydraulic valve opening(s), so that the load to the engine is adjusted, and achieve engine anti-stall while achieving maximum control response. The system 50 may provide a measured response to sudden loading of the engine at all low engine speed conditions without requiring an anti-stall valve.

The engine anti-stall control system 50 may be understood to comprise a static sliding mode controller 51, a transient sliding mode controller 53, and a load probe 57. The static and transient sliding mode controllers 51, 53 may be configured to adjust the hydraulic torque load to the engine based on the engine revolution speed and acceleration (or deceleration). The sliding mode controller(s) may be configured to achieve transient engine anti-stall objectives.

The static sliding mode controller 51 may be configured to monitor and control aspects of static engine performance associated with the present speed of the engine, e.g., the initial speed of the engine. The transient sliding mode controller 53 may be configured to monitor and control aspects of transient engine performance associate with changes in engine speed, e.g., acceleration or deceleration, associated with hydraulic performance or load.

The load probe 57 may comprise an integrator configured to dynamically estimate the load and limit the maximum pump flow rate. The engine anti-stall control system 50 may be used to ensure that the maximum torque demand to the engine does not exceed the available engine torque at different speeds. The load probe 57 may be configured to achieve steady-state engine anti-stall objectives. The load probe 57 may be understood to integrate the static and transient engine performance operations or responses. Other adjustment or modification components may be used to suppress or reduce system oscillations and to enhance the anti-stall performance, as described further, herein.

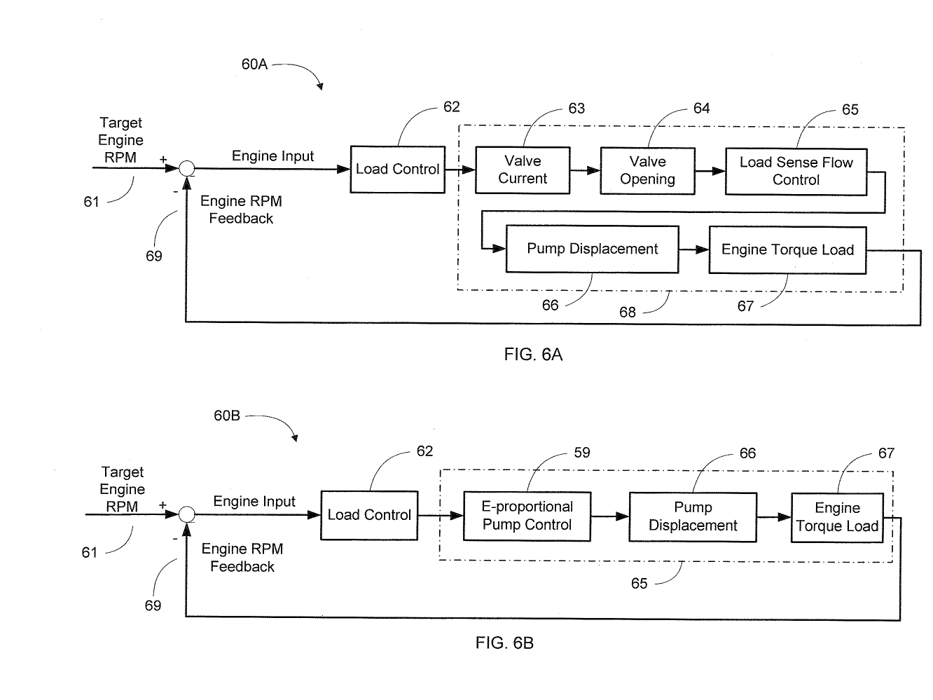

FIGS. 6A and 6B are simplified diagrams illustrating the engine anti-stall control system 50 as depicted in FIGS. 5A and 5B. For example, the diagram 60A may be used to illustrate how the engine anti-stall control system 50 may be configured to operate with an engine and hydraulic system 68. A processing device may receive a target engine speed 61 as input. In one embodiment, the processing device, such as a load controller 62, may be configured to identify the initial engine speed of the industrial vehicle. The initial engine speed may correspond to the idle engine speed of the industrial vehicle. In one embodiment, the initial engine speed may correspond to an operation of the industrial vehicle without hydraulic load. The processing device further may be configured to monitor a rate of change in engine speed 69. Inputs to the load controller 62 may include the magnitude of the change, e.g., decrease, in engine speed, as well as the rate of change, e.g., deceleration rate, of the engine.

A variable displacement pump may be configured to vary a hydraulic flow associated with the hydraulic system based, in part, on the rate of change in the engine speed 69. The control valve, e.g., control valve 31 of FIG. 3, may comprise a closed center proportional valve 33, an electro-hydraulic proportional valve, a directional control valve, other types of hydraulic valves, or any combination thereof. The diagram 60B of FIG. 6B illustrates how this same control concept can be applied with manual or ON/OFF control valves by directly controlling an electro-proportional controlled variable displacement pump 59.

The load controller 62 may be configured to adjust a valve current 63 associated with the control valve. The valve current 63 may in turn be configured to adjust the amount of valve opening 64 of the control valve. The load sense flow control 65 may automatically control the pump displacement 66 in response to the hydraulic valve opening 64. In one embodiment, the hydraulic flow may be varied according to a mapped response to the rate of change in the engine speed. The engine speed may be maintained at or below the initial engine speed while the hydraulic flow is varied.

The adjusted pump displacement 66 may operate to vary the engine torque load 67. For example, increasing the pump displacement 66 may result in an increased engine torque load 67. Decreasing the pump displacement 66 may result in a decreased engine torque load. By adjusting the pump displacement 66, the engine torque load 67 may be adjusted.

An increase in the engine torque load 67 may result in a reduced engine speed. Conversely, a decrease in the engine torque load 67 may result in an increased engine speed. An effect of the change in the engine torque load 67, and similarly of the pump displacement 66, may be measured, compared, or analyzed with respect to the rate of change in the engine speed 69, or engine speed feedback.

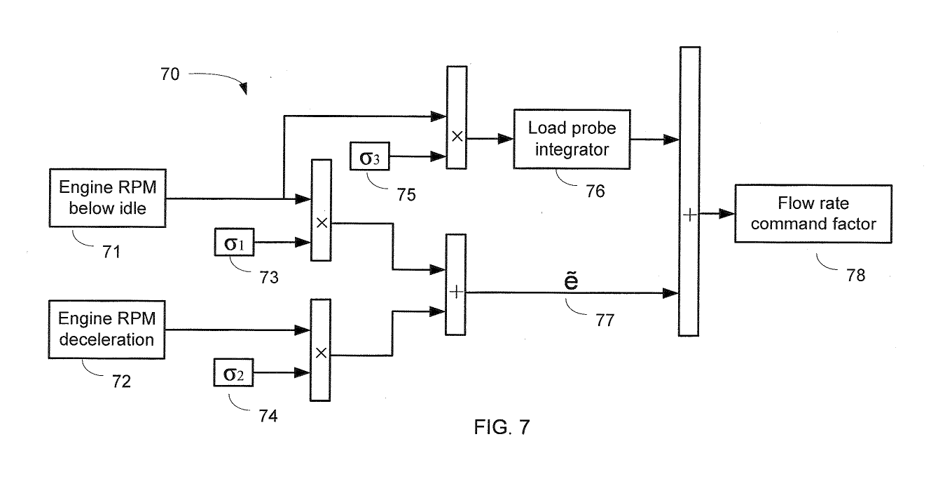

FIG. 7 is an architectural diagram illustrating the engine anti-stall control system 50 as depicted in FIGS. 5A and 5B. The diagram may be used to describe the architecture of the engine anti-stall control system 50.

Robust Sliding Mode Controller for Hydraulic Engine Load Control

The engine speed offset may be defined as follows:

eᵣₚₘ=n−n_{idle} (9)

Where

eᵣₚₘ—engine speed offset

n_{idle}—engine idle speed 71

Accordingly, ėᵣₚₘ, or the rate of change in engine speed 72, may be defined as the first order time derivative of the engine speed offset eᵣₚₘ.

The sliding surface of the sliding mode control may be defined as:

\tilde{e}=σ₁eᵣₚₘ+σ₂ėᵣₚₘ (10)

Where

\tilde{e}—sliding surface 77

σ₁—weight of engine speed offset 73 in the sliding surface

σ₂—weight of the engine acceleration 74 in the sliding surface

σ₃—gain of the time derivative of engine speed 75 in the load probe

The sliding mode controller 70 may be configured to let the engine states converge to its equilibrium points along this sliding surface. In general control cases, this may be achieved by a Lyapunov method. A positive definite Lyapunov function V(x) may be defined, wherein the first order derivative of V(x) is non-positive definite in the state domain.

Load Probe

The load probe 76 may comprise an integrator configured to accumulate the offset of the engine speed below idle. In one embodiment, the maximum hydraulic torque load to the engine may be controlled such that it does not exceed the available engine torque output, e.g., so that the steady state engine anti-stall can be achieved. The load probe 76 may be analytically expressed as:

f_{load}=σ₃∫(n−n_{idle})dt (11)

An apparatus may comprise means for identifying the initial engine speed 71 of the industrial vehicle, and means for monitoring the rate of change in engine speed 72. The apparatus may comprise means for varying a hydraulic flow 78 associated with a hydraulic system based, in part, on the rate of change in the engine speed, and means for maintaining the engine speed at or below the initial engine speed while the hydraulic flow is being varied. The engine speed may be maintained above an engine stall speed while the hydraulic flow is being varied.

The apparatus may comprise means for measuring an amount of change in the engine speed and a length of time associated with the amount of change in the engine speed to obtain an engine response. The hydraulic flow may be varied based, in part, on the engine response. In one embodiment, a constant hydraulic pressure associated with the hydraulic system may be maintained while the hydraulic flow is varied.

The amount of change in the engine speed may correspond to a difference between the initial engine speed and an instantaneous engine speed. In one embodiment, the rate of change in the engine speed may be monitored while the industrial vehicle is lifting a load. The rate of change in the engine speed may be monitored while the industrial vehicle is stationary.

In one embodiment a unique equilibrium point is provided at any one moment. In another embodiment, there may be multiple equilibrium points associated with different loads. The engine speed may be stabilized above or equal to the idle speed. For purposes of illustration, the engine anti-stall control system described with reference to architectural diagram 70 may comprise a closed-loop system. The closed-loop system may be controlled by a PID type controller.

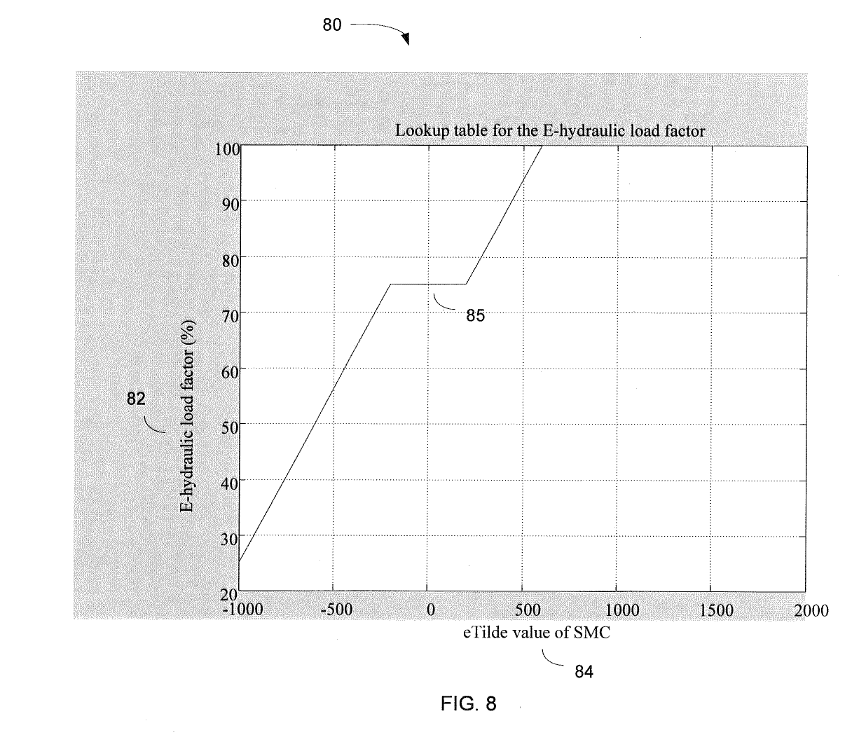

FIG. 8 is an example look-up table 80 illustrating a hydraulic load factor 85. The look-up table 80 may be used instead of, or in place of, a mathematical relationship, such as the Lyapunov function. In one embodiment, the look-up table 80 may be configured to cause the engine speed to converge at points at or above the engine idle speed. The E-hydraulic torque load factor 82 may be defined by a continuous curve. It may be monotonous with respect to the sliding surface 84, or \tilde{e}.

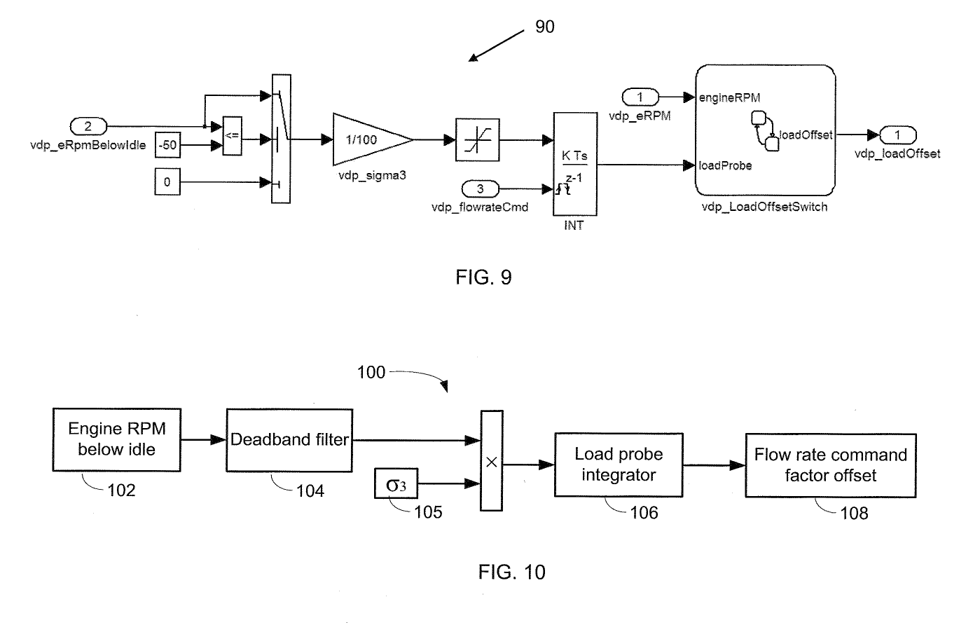

FIG. 9 is a logic diagram illustrating an accumulator system 90 configured to accumulate an engine speed offset. The accumulator system 90, illustrated as a simulated block diagram, discloses that the load probe may be configured to measure the transient sinking of the engine speed when the E-hydraulic operation is active.

Given a certain throttle opening, the value of the transient may monotonously increase with the increase of load. Therefore, the transient value may achieve steady-state equilibrium of the engine power output and the E-hydraulic operation power requirement. Moreover, the load probe and sliding mode control design may be configured to allow relatively higher idle E-hydraulic operation flow rate without having to further adjust for the heaviest rated load associated with the industrial vehicle. When the engine speed is sufficiently high to avoid engine stall, the load offset may be switched off. Switching off the load offset may provide for full hydraulic operation of the E-hydraulic system regardless of any change in engine speed above an engine stall threshold.

FIG. 10 is a simplified diagram 100 illustrating the accumulator system 90 depicted in FIG. 9. The engine speed below idle 102 may be provided as input to a deadband filter 104. The deadband filter 104 may be used to determine engine revolution acceleration used in the sliding mode control. The engine revolution acceleration may be modified by the gain of the time derivative of engine speed 105 as input to the load probe 106. The load probe 106 may then be configured to determine a factor offset for the flow rate command.

There are a number of conditions, relationships, or objectives that may be used to determine the modifications for oscillation suppression and engine anti-stall. For example, due to the asymmetry of the engine torque, the positive engine revolution acceleration associated with engine deceleration may be ignored. Also, the torque reduction may be considered as being immediate and significant. Additionally, when the engine accelerates, the torque increase may be considered as being relatively gradual with a delay. The following modification may be applied to the weight of the engine revolution acceleration:

$${σ}_{2} = \{ \begin{matrix}{σ}_{2} & if \dot{n} < 0 \\ 0 & if \dot{n} \geq 0\end{matrix} \qquad ( 12 )$$

In order to ensure absolute engine anti-stall performance during transient phase, the weight of the engine revolution acceleration σ₂ may be defined relatively high. When the equilibrium point is achieved, the flow rate command factor may fluctuate and result in oscillations in the hydraulic system. Therefore, an engine revolution acceleration dead-band may be applied after nonzero E-hydraulic command is on for a certain period of time. The deadband may be expressed as follows:

$${\dot{n}}_{out} = \{ \begin{matrix}\dot{n} & if {t}_{EHyd} < {τ}_{transient} \\ 0 & if ( {t}_{EHyd} \geq {τ}_{transient} ) \& ( \vert \dot{n} \vert < δ ) \\ \dot{n} & if ( {t}_{EHyd} \geq {τ}_{transient} ) \& ( \vert \dot{n} \vert \geq δ )\end{matrix} \qquad ( 13 )$$

Where

\dot{n}ₒᵤₜ—engine revolution acceleration used in the sliding mode control.

t_{EHyd}—time of non-zero E-hydraulic operation. It may start and/or reset from the instant that non-zero flow rate command is generated.

tₜᵣₐₙₛᵢₑₙₜ—a constant marking the transient period. It may be defined as a period of time, transient such as 1 to 2 seconds.

δ—dead-band value. After the transient period, if \dot{n} is less than δ, \dot{n} may be neglected.

As described above with respect to equation (2), when the equilibrium point is achieved, the high frequency components of engine revolution speed may be filtered out to reduce the oscillation in hydraulic system. Engine speed smoothing using a low-pass filter may be expressed as:

$${n}_{out} = \{ \begin{matrix}n & if {t}_{EHyd} < {τ}_{transient} \\ {n}_{filtered} & if {t}_{EHyd} \geq {τ}_{transient}\end{matrix} \qquad ( 14 )$$

Where

n_{filtered}—filtered engine revolution speed signal.

Parameter Tuning

It is difficult and less meaningful to discuss the effect of the parameters, e.g., σ₁, σ₂, and σ₃ individually. In some embodiments, the parameters work jointly to produce a combined effect, and their relative values may be more important than their single value definition. The parameters may comprise preset or predefined constants that are determined or established for a particular type or class of industrial vehicles. Different industrial vehicles, e.g., that are rated to transport or handle different load, may be associated with different sets of parameters. Similar to PID controller tuning, parameter tuning of the engine anti-stall control system may be described through a table, such as Table 1 shown below:

TABLE 1
Parameter tuning of the engine anti-stall control system

| Param- | | Effect to engine | Effect to |
|---|---|---|---|
| eters | Description | anti-stall | oscillation |
| σ₁ | The weight | It affects the steady- | The higher, the |
| | of n in the | state engine anti- | more oscillation. |
| | sliding | stall: the lower, | The low-pass |
| | mode surface. | the less engine | filter alleviates |
| | | anti-stall robust. | this issue. |
| σ₂ | The weight | It affects the transient- | The higher, the |
| | of \dot{n} in the | state engine anti- | more oscillation. |
| | sliding | stall: the lower, | The dead-band |
| | mode surface | the less engine | when steady- |
| | | anti-stall robust. | state alleviates |
| | | | this issue |
| σ₃ | The gain of ∫ ndt | It compensates the | It has little |
| | in the load | steady-state engine | effect |
| | probe to calculate | anti-stall. The higher, | on the oscil- |
| | the flow rate | the more robust | lation: it may |
| | command offset. | the engine anti-stall | excite a tran- |
| | | performance. | sient |
| | | | oscillation. |
| Flow | Defines the | At low engine | The smoother |
| rate | flow rate command | RPM, the lower | the whole |
| factor | factor w.r.t. \tilde{e}. | the profile, the | curve, the |
| LUT | | more robust the engine | less oscillation. |
| | | anti-stall performance. | |
| \dot{n} dead- | The dead-band | The bigger, the less | The bigger, |
| band | defined | robust the engine anti- | the less |
| | to reduce oscillation | stall performance. | oscillation. |
| | when steady-state. | | |
| n LPF | The bandwidth to | The bigger, the less | The bigger, |
| band- | filter the engine | robust the engine anti- | the less |
| width | speed signal when | stall performance. | oscillation. |
| | steady-state. | | |

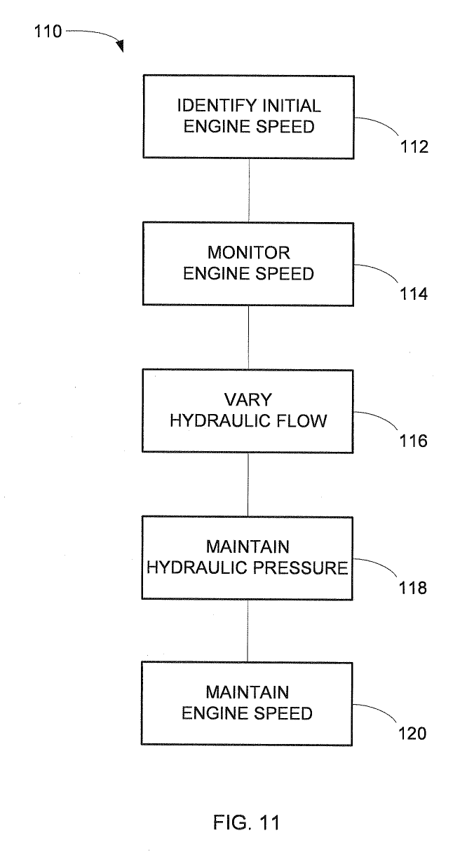

FIG. 11 illustrates an example process 110 for varying hydraulic flow to prevent engine stall. At operation 112, an initial engine speed of the industrial vehicle may be identified. In one embodiment, process 110 may be associated with a stationary vehicle, e.g., no or little tractive effort is being applied to industrial vehicle, with the engine operating at low idle speeds.

At operation 114, a rate of change in engine speed may be monitored. The rate of change in engine speed, e.g., as measured by the number of revolutions per minute, may reflect the engine's response to the hydraulic load. The amount and length of time the engine speed changes, e.g., decreases, may be measured to determine the instantaneous engine performance or response to the hydraulic load.

At operation 116, a hydraulic pump or a control valve may be controlled to vary a hydraulic flow associated with a hydraulic system based, in part, on the rate of change in the engine speed. In one embodiment, the hydraulic flow may be varied independent of the hydraulic load. The hydraulic flow may be varied without directly measuring engine torque. Furthermore, the hydraulic flow may be varied without increasing the engine speed, e.g., without increasing the target or desired engine speed.

The instantaneous engine speed of the industrial vehicle may be measured. The instantaneous engine speed may be multiplied by a first constant to obtain a first input. The rate of change in engine speed may be multiplied by a second constant to obtain a second input. The first constant and the second constant may comprise fixed constants that are predefined for the industrial vehicle. A sliding control may be obtained by combining the first input with the second input. In one embodiment, the hydraulic flow may be varied based, in part, on the sliding control.

At operation 118, the engine speed may be maintained at or below the initial engine speed while the hydraulic flow is being varied. In one embodiment, the engine speed may be maintained above an engine stall speed while the hydraulic flow is being varied. The initial engine speed generally may be controlled or determined by a position of the accelerator pedal. The engine speed may be controlled independent of hydraulic load, or independent of a hydraulic pressure associated with the load.

Whereas the engine speed may be directly controlled by the accelerator pedal, it may also be indirectly controlled by varying the hydraulic flow. For example, the accelerator pedal may control the engine to operate at a target or desired engine speed, such as a low idle speed. By varying the hydraulic flow, the engine speed may be maintained at or near the target engine speed, and above the engine stall speed, while performing a hydraulic function such as hoist. Stated another way, adjusting the hydraulic flow may be used to assist or maintain the target engine speed as commanded by the accelerator pedal, and avoid engine stall. The hydraulic flow may be adjusted, for example decreased, while maintaining substantially the same effective engine performance.

At operation 120, a constant hydraulic pressure associated with the hydraulic system may be maintained while varying the hydraulic flow. The hydraulic flow may be varied by adaptively controlling the variable displacement hydraulic pump as a function of monitored engine speed. The hydraulic flow may be varied without modifying the requested engine performance, e.g., as requested by the accelerator pedal. The process 110 provides the ability to maximize the hydraulic pump performance within the constraints of the engine performance.

The engine anti-stall system may be implemented on an internal combustion engine powered E-hydraulic system with a variable displacement pump. The hydraulic torque load to the engine may be adjusted based on the engine's speed responses to the hydraulic load, without measuring the load itself. In one embodiment, the only vehicle system input required to adjust the hydraulic torque load is the engine revolution speed. The hydraulic torque load may be adjusted by changing the valve opening and thereby the hydraulic pump flow to control an amount of torque applied to the engine. The control valve opening may be controlled by a processing device, e.g., controller, computer, etc., which is configured to execute computer-readable instructions. In one embodiment, the valve opening is controlled independent of the load, e.g. the weight of the material, being handled by the industrial vehicle. The systems, apparatus, and method described herein provide a low cost, efficient, and high hydraulic operation response speed without using additional hardware such as a solenoid valve to drain pump flow when the engine speed is low.

The system and apparatus described above may use dedicated processor systems, micro controllers, programmable logic devices, or microprocessors that may perform some or all of the operations described herein. Some of the operations described above may be implemented in software and other operations may be implemented in hardware. One or more of the operations, processes, or methods described herein may be performed by an apparatus, device, or system similar to those as described herein and with reference to the illustrated figures.

The processing device may execute instructions or “code” stored in memory. The memory may store data as well. The processing device may include, but may not be limited to, an analog processor, a digital processor, a microprocessor, multi-core processor, processor array, network processor, etc. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, storage array, or portable FLASH key fob. The memory and processing device may be operatively coupled together, or in communication with each other, for example by an I/O port, network connection, etc. such that the processing device may read a file stored on the memory. Associated memory may be “read only” by design (ROM) by virtue of permission settings, or not. Other examples of memory may include, but may not be limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

Operating instructions or commands may be implemented or embodied in tangible forms of stored computer software (also known as a “computer program” or “code”). Programs, or code, may be stored in a digital memory that may be read by the processing device. “Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. We claim all modifications and variation coming within the spirit and scope of the following claims.

1. A method comprising:
identifying an initial engine speed of an industrial vehicle;
monitoring a rate of change in engine speed;
controlling a hydraulic pump to vary a hydraulic flow associated with a hydraulic system based, in part, on the rate of change in the engine speed; and
maintaining the engine speed at or below the initial engine speed while the hydraulic flow is being varied.

2. The method of claim 1, wherein the engine speed is maintained above an engine stall speed while the hydraulic flow is being varied.

3. The method of claim 1, further comprising maintaining a constant hydraulic pressure associated with the hydraulic system while varying the hydraulic flow.

4. The method of claim 1, further comprising:
measuring an instantaneous engine speed;
multiplying the instantaneous engine speed by a first constant to obtain a first input;
multiplying the rate of change in engine speed by a second constant to obtain a second input; and
combining the first input with the second input to obtain a sliding control, wherein the hydraulic flow is varied based, in part, on the sliding control.

5. The method of claim 4, wherein the first constant and the second constant are fixed constants that are predefined for the industrial vehicle.

6. The method of claim 1, wherein varying the hydraulic flow comprises varying the hydraulic flow independent of a hydraulic load, wherein the rate of change in engine speed indicates an engine response to the hydraulic load.

7. The method of claim 1, further comprising managing a flow command to a control valve to indirectly control the hydraulic pump.

8. A system comprising:
a processing device configured to:
identify an initial engine speed of an industrial vehicle; and
monitor a rate of change in engine speed; and
a variable hydraulic flow device configured to vary a hydraulic flow associated with a hydraulic system based, in part, on the rate of change in the engine speed, wherein the engine speed is maintained at or below the initial engine speed while the hydraulic flow is varied.

9. The system of claim 8, wherein the initial engine speed corresponds to an idle engine speed of the industrial vehicle.

10. The system of claim 9, wherein the initial engine speed further corresponds to an operation of the industrial vehicle without hydraulic load.

11. The system of claim 8, wherein the hydraulic flow is varied according to a mapped response to the rate of change in the engine speed.

12. The system of claim 8, wherein the variable hydraulic flow device comprises a control valve.

13. The system of claim 8, wherein the hydraulic flow device comprises a variable displacement pump.

14. An apparatus, comprising:
means for identifying an initial engine speed of an industrial vehicle;
means for monitoring a rate of change in engine speed;
means for varying a hydraulic flow associated with a hydraulic system based, in part, on the rate of change in the engine speed; and
means for maintaining the engine speed at or below the initial engine speed while the hydraulic flow is being varied.

15. The apparatus of claim 14, wherein the engine speed is maintained above an engine stall speed while the hydraulic flow is being varied.

16. The apparatus of claim 14, further comprising means for measuring an amount of change in the engine speed and a length of time associated with the amount of change in the engine speed to obtain an engine response, wherein the hydraulic flow is varied based, in part, on the engine response.

17. The apparatus of claim 14, wherein the amount of change in the engine speed corresponds to a difference between the initial engine speed and an instantaneous engine speed.

18. The apparatus of claim 14, wherein the rate of change in the engine speed is monitored while the industrial vehicle is lifting a load.

19. The apparatus of claim 18, wherein the rate of change in the engine speed is monitored while the industrial vehicle is stationary.

20. The apparatus of claim 14, wherein a constant hydraulic pressure associated with the hydraulic system is maintained while the hydraulic flow is varied.
